(19) United States
(12) Patent Application Publication
(10) Pub. No.: US 2007/0201918 A1
(43) Pub. Date: Aug. 30, 2007

(54) Image copier and image copying method

(75) Inventors: Hirokazu Shoda, Kanagawa-ken (JP); Naoaki Ide, Shizuoka-ken (JP); Yusuke Hashizume, Chiba-ken (JP); Kunihiko Miura, Kanagawa-ken (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/365,332

(22) Filed: Feb. 28, 2006

(51) Int. Cl. G03G 15/00

(52) U.S. Cl. 399/376

(57) ABSTRACT

An image copier of the invention includes a document table to position a document from which an image is read, a document holding cover to hold the document on the document table, a light source to irradiate light to the document when the image of the document is read, and an image reading light receiving element to receive reflected light from the document, and the document holding cover includes a document size detecting light emitting element to emit light at a time of document size detection. According to the image copier of the invention, the document size can be accurately detected independently of the kind of the document.

### BACKGROUND OF THE INVENTION

1. Field of the Invention

The present invention relates to an image copier and an image copying method, and particularly to an image copier and an image copying method, in which an accurate document size can be detected regardless of the kind of document.

2. Related Art

JP-A-61-51447 discloses an image copier in which an infrared ray emitting element is arranged on a document holding cover (platen cover), and document size detection is performed by a light receiving element arranged below a document table glass (platen glass) to be opposite thereto.

Further, JP-A-5-207239 discloses an image copier in which an exposure lamp is used, reflected light of the exposure lamp is received by a CCD sensor, and document size detection is performed.

In the image copier disclosed in JP-A-61-51447, since the infrared ray emitting element is used, in the case where a CCD as a document reading element is used as the light receiving element, there may be a fear that a CCD sensor having high sensitivity to infrared rays is damaged. Accordingly, a dedicated light receiving element is required instead of the CCD. Since the dedicated light receiving element is relatively expensive as compared with the CCD, the cost of the image copier is increased. Further, since it is necessary to arrange the light receiving element inside of a scanner casing, the thickness of the scanner casing is increased.

In the image copier disclosed in JP-A-5-207239, at the time of document size detection, the exposure lamp is caused to emit light in a state where the platen cover is closed to a specified angle, and the document size detection is performed. That is, since the detection operation of the document size is performed before the platen cover is completely closed, there maybe a fear that an erroneous detection occurs by the influence of external light.

Further, since the reflected light of the exposure lamp is used, in the case of a photographic document or the like in which the whole document is printed with a dark color tone or the like, the quantity of reflected light by the document is lowered, and there may be a fear that a size detection error occurs.

Then, an image copier and an image copying method, in which an accurate document size can be detected independently of a document, are desired.

### SUMMARY OF THE INVENTION

The invention has been made in view of the above circumstances, and has an object to provide an image copier and an image copying method, in which a document size can be accurately detected regardless of the kind of document.

In order to solve the problem, an image copier of the invention includes a scanner configured to read an image and a printer configured to form the image on a sheet. The scanner includes a document table configured to position a document from which the image is read, a light source configured to irradiate a light to the document when the image of the document is read, an image reading light configured to receive element configured to receive reflected light from the document, a document holding cover configured to hold the document on the document table and to include a document size detecting light emitting element to emit light at a time of document size detection and a document size detecting light emitting element controller configured to control the document size detecting light emitting element.

In order to solve the problem, an image copying method of the invention includes: detecting a size of a document as an image read object, reading an image from the document, and forming the image read at the image read step. The document size detection step includes: receiving light irradiated by causing a document size detecting light emitting element to emit light, extracting a specified pixel group including a pixel corresponding to the document size detecting light emitting element, determining whether a CCD output value of the pixel group extracted at the pixel extraction step exceeds a previously set threshold value, and determining the size of the document of the image read object based on a determination result at the threshold value determination step.

In the image copier and the image copying method according to the invention, since the light irradiated from the document size detecting light emitting element is directly used without being reflected in the state where the document holding cover is closed, the high-precision document size detection independent of the influence of external light and the kind of document can be performed.

### BRIEF DESCRIPTION OF THE DRAWINGS

In the accompanying drawings;

FIG. 1 is a schematic view showing a structure of an image copier of a first embodiment of the invention;

FIG. 2 is a schematic view showing a structure of a scanner included the image copier of the first embodiment of the invention;

FIG. 3 is a schematic view explaining a structure and a control object of a scanner controller in the image copier of the first embodiment of the invention;

FIG. 4 is a plan view in a case where an example (positioning reference of a document is a corner) of a document holding cover in the image copier of the first embodiment of the invention is seen from a document table glass side;

FIG. 5 is a plan view in a case where an example (positioning reference of a document is the center) of a document holding cover in the image copier of the first embodiment of the invention is seen from the document table glass side;

FIG. 6 is a schematic view showing a structure of a document size detector in the image copier of the first embodiment of the invention;

FIG. 7 is a view explaining the concept of a threshold value determination which is made by a threshold value determination element in the image copier of the first embodiment of the invention;

FIG. 8 is a schematic view showing a structure of a printer included the image copier of the first embodiment of the invention;

FIG. 9 is a view showing an applied example of the image copier of the first embodiment of the invention and explaining a scene where it is used as a copying machine;

FIG. 10 is a view showing an applied example of the image copier of the first embodiment of the invention and explaining a scene where it is used as a network printer;

FIG. 11 is a view showing an applied example of the image copier of the first embodiment of the invention and for explaining a scene where it is used as a network scanner;

FIG. 12 is a flowchart explaining a document size detection step in an image copying method of the first embodiment of the invention;

FIG. 13 is a schematic view showing a structure of a scanner included an image copier of a second embodiment of the invention;

FIG. 14 is a schematic view for explaining a structure and a control object of a scanner controller in the image copier of the second embodiment of the invention;

FIG. 15 is a plan view in a case where an example (positioning reference of a document is a corner) of a document holding cover of the image copier of the second embodiment of the invention is seen from a document table glass side;

FIG. 16 is a plan view in a case where an example (positioning reference of a document is the center) of a document holding cover of the image copier of the second embodiment of the invention is seen from the document table glass side;

FIG. 17 is a schematic view showing a structure of a document size detector in the image copier of the second embodiment of the invention;

FIG. 18 is a flowchart explaining a document size detection step in an image copying method of the second embodiment of the invention;

FIG. 19 is a schematic view showing a structure of a scanner included an image copier of a third embodiment of the invention;

FIG. 20 is a view explaining a relation between a basis weight of a document and a CCD output value of a CCD line sensor; and

FIG. 21 is a view explaining a correlation between a current passing through an LED and a light emission quantity of the LED.

### DETAILED DESCRIPTION OF THE PREFERRED EMBODIMENTS

Embodiments of an image copier and an image copying method of the invention will be described with reference to the accompanying drawings.

Incidentally, up, down, right and left directions in the specification are based on a normal device use state except when an explanation is particularly made.

### First Embodiment

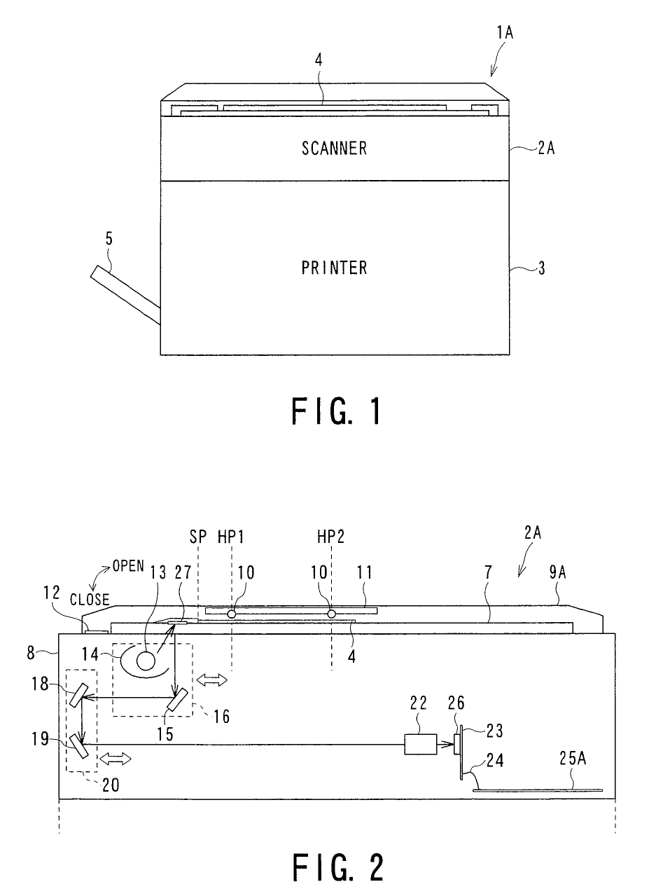

FIG. 1 is a schematic view showing a structure of an image copier 1A as an example of an image copier of a first embodiment of the invention.

The image copier 1A includes a scanner 2A for reading an image, and a printer 3 for forming the image and printing the formed image on a sheet.

The scanner 2A reads a document 4 positioned to read the image. In the case where the read image is formed, the scanner 2A transmits the information of the read image to the printer 3.

The printer 3 forms the image on a sheet based on the information of the image to be formed, and then prints out the sheet on which the image has been formed to a sheet discharge tray 5.

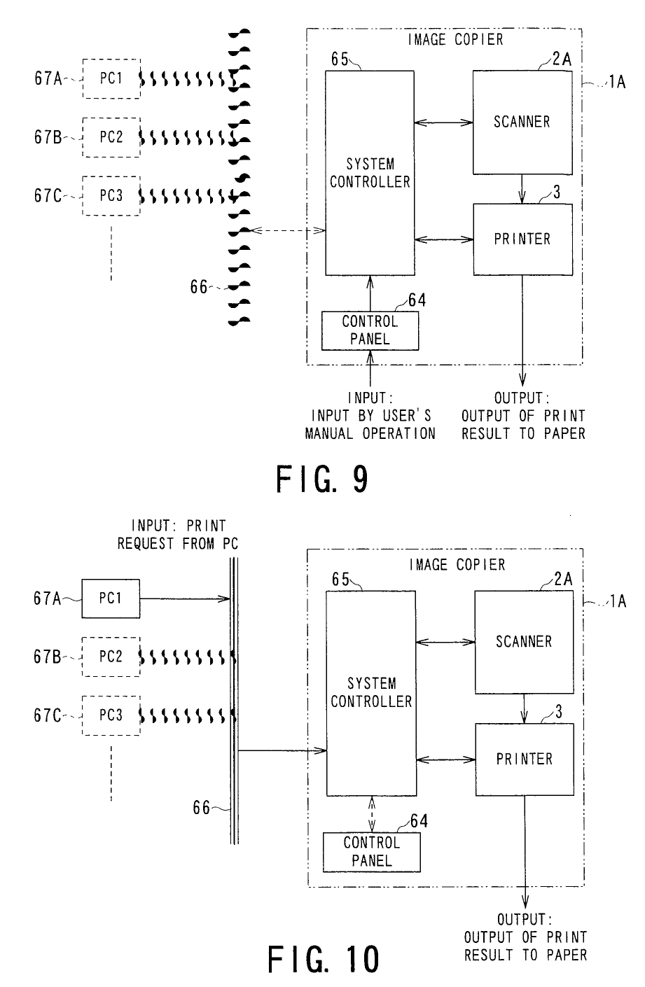

Incidentally, although the image copier 1A further includes a system controller to perform a control and a control panel as a user interface, they are omitted in FIG. 1 (see FIG. 9 to FIG. 11).

Further, there is also a case where the scanner 2A does not transmit the read image information to the printer 3, but transmits it to a not-shown recording device or the like.

Furthermore, there is also a case where the information of the image to be formed by the printer 3 is received from a not-shown device other than the scanner 2A or is stored in the printer 3.

Next, the structure and operation of the scanner 2A in the image copier 1A will be described.

FIG. 2 is a schematic view showing a structure of the scanner 2A included the image copier 1A.

Note that FIG. 2 shows the image copier 1A in a state where the document 4 as an image read object is set.

In the scanner 2A, a document holding cover 9A is openablely and closablely provided to a casing 8 including a document table glass 7 as a document table.

The document table glass 7 is provided on an upper surface of the casing 8. At the time of image read, the read surface of the document 4 as the image read object points downward, and is positioned on the document table glass 7.

The document holding cover 9A is fixed to the casing 8 at its end so as to be openable and closable, and presses the document 4 positioned on the document table glass 7 onto the document table glass 7 by closing the document holding cover 9A. Besides, a plurality of LEDs (Light Emitting Diodes) 10, which are document size detecting light emitting elements to irradiate light to the document 4 when the size of document 4 is detected, are arranged on the document holding cover 9A. The control of the LEDs 10, for example, switching on and off of the LEDs 10 at the time of document detection, is performed by an LED controller 11A as a document size detecting light emitting element controller provided on the document holding cover 9A.

Besides, a cover opening/closing detection sensor 12 to detect the opening/closing state of the document holding cover 9A is provided in the casing 8.

On the other hand, inside the casing 8, there are provided a light source 13, a first carriage 16 having a reflector 14 and a first mirror 15, a second carriage 20 having a second mirror 18 and a third mirror 19, a collective lens 22, a CCD (Charge Coupled Device) sensor board 23 as an optical/electrical conversion device, and a control board 25A as a scanner controller electrically connected to the CCD sensor board 23 through an electric connecter such as, for example, a harness 24.

Incidentally, there is also a case where the LED controller 11A is mounted on the control board 25, or is mounted at another position in the scanner 2 or the printer 3.

Besides, reference character SP shown in FIG. 2 denotes a document read start position at the time of image read processing. Further, HP1 and HP2 denote a first home position and a second home position, and indicate a position of the first carriage 16 at the time of document size detection. The details of the document size detection processing will be described later.

In the scanner 2A configured as stated above, at the time of image read, first, light from the light source 13 is irradiated to the document 4, and is reflected by the document 4. The reflected light reflected by the document 4 is imaged on a sensor surface of a CCD line sensor 26 as a photoelectric element mounted on the CCD sensor board 23 through the first mirror 15, the second mirror 18, the third mirror 19, and the condenser lens 22.

The first carriage 16 and the second carriage 20 can be moved by the driving of a motor which is not shown in FIG. 2. The first carriage 16 and the second carriage 20 are moved so that the irradiation light from the light source 13 is scanned. Besides, in the image copier 1A, the optical path (light path) length from the original document 4 up to the CCD line sensor 26 is controlled to be constant by setting the moving speed of the first carriage 16 at twice the moving speed of the second carriage 20.

The CCD line sensor 26 successively reads the document 4 placed on the document table glass 7 line by line, and converts it into an analog electric signal corresponding to the intensity of the light signal as the reflected light. Then, the converted analog electric signal is transmitted to the control board 25A connected to the CCD sensor board 23 through the harness 24.

The control board 25A converts the analog electric signal received from the CCD line sensor 26 into a digital signal. Then, the control board 25A performs a digital signal processing such as a shading (distortion) correction to correct a low frequency distortion due to the condenser lens 22 or a high frequency distortion caused by the fluctuation of sensitivity of the CCD line sensor 26.

When the shading correction is performed, a signal as a reference of black and a signal as a reference of white are required. The signal as the reference of black is an output signal of the CCD line sensor 26 when the light source 13 is placed into a switching-off state and in a state where light is not irradiated to the CCD line sensor 26. The signal as the reference of white is an output signal of the CCD line sensor 26 when the light source 13 is placed into a switching-on state and the reflected light from a white reference plate 27 is read. Further, when the signals as the reference of black and white are generated, in order to reduce an influence due to a singular point or a quantization error, it is generally performed to average signals for plural lines.

Note that the AD conversion processing performed by the control board 25A may be performed in the CCD sensor board 23. The CCD line sensor 26 may be another photoelectric element.

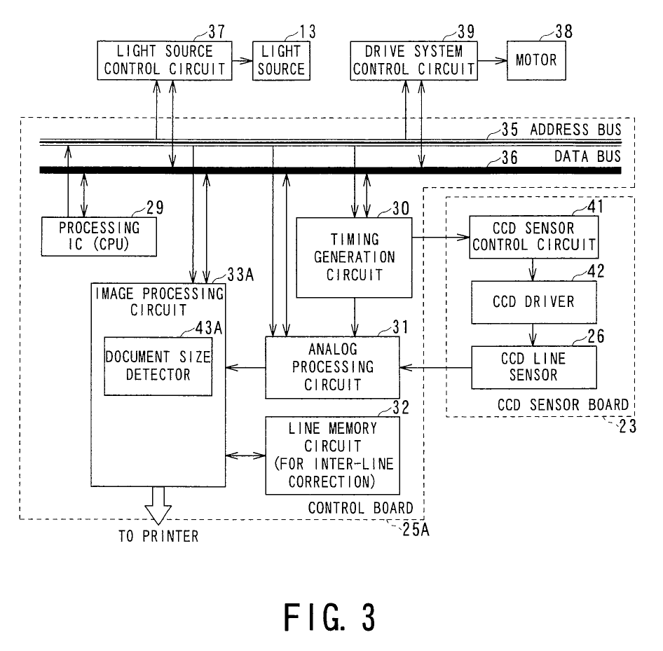

FIG. 3 is a schematic view explaining a structure and a control object of the control board 25A as the scanner controller in the image copier 1A.

The control board 25A includes a processing IC 29 such as a CPU, a timing generation circuit 30, an analog processing circuit 31, a line memory circuit 32, and an image processing circuit 33A.

The processing IC 29 performs the detection of an opening/closing state of the document holding cover 9A, the control of a signal processing as to a signal transmitted from the CCD line sensor 26, the control of a light source control circuit 37 to perform the control of the light source 13 connected through a bus such as an address bus 35 and a data bus 36, and the control of a drive control circuit 39 for controlling a motor 38 to move the first carriage 16 and the second carriage 20.

The timing generation circuit 30 generates a signal necessary for driving the CCD line sensor 26 and a signal necessary for an analog processing performed in the analog processing circuit 31.

The signal generated by the timing generation circuit 30 and necessary for driving the CCD line sensor 26 is subjected to timing adjustment by a CCD sensor control circuit 41 mounted on the CCD sensor board 23, and is transmitted to a CCD driver 42. Then, after signal amplitude leveling or waveform shaping is performed by the CCD driver 42, an input is made to the CCD line sensor 26.

The signal necessary for the analog processing is inputted to the analog processing circuit 31. The analog processing circuit 31 performs various analog processings, and then transmits the signals performed analog processing to the image processing circuit 33A.

The line memory circuit 32 corrects a position shift generated when each line sensor of the CCD line sensor 26 reads.

The image processing circuit 33A includes a document size detector 43A to detect a document size. The image processing circuit 33A performs, in addition to the document size detection processing performed by the document size detector 43A, the control of the line memory circuit 32, the shading correction performed by using the image signal converted into the digital signal, the enlargement/reduction processing, and the image processing such as LOG conversion.

Incidentally, in FIG. 3, although the control board 25A includes the analog processing circuit 31, the CCD sensor board 23 may include the analog processing circuit 31. Besides, the CCD control circuit 41 may be included in the timing generation circuit 30.

Next, a description will be given to the structure of the document size detector 43A and a document size detection method performed by the document size detector 43A.

The document size detector 43A determines the output levels of the light irradiated from the LEDs 10 arranged at specified positions of the document holding cover 9A as shown in FIG. 2, and detects whether the document 4 exists on the light paths between the LEDs 10 and the CCD line sensor 26. Then, the document size detector 43A determines the size of the document 4 based on the detection result of the document 4.

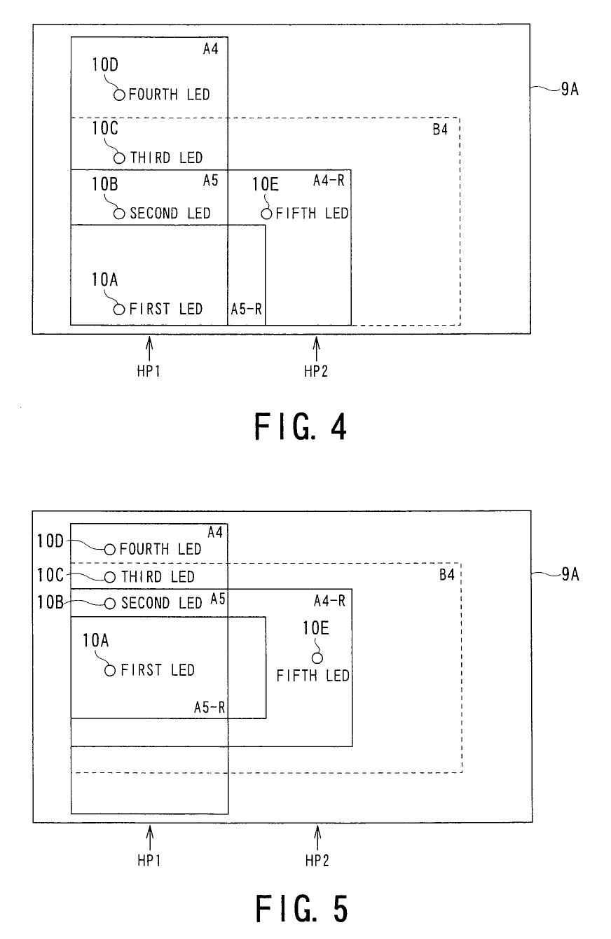

FIG. 4 and FIG. 5 are plan views in the case where the document holding cover 9A of the scanner 2A in the image copier 1A is seen from the document table glass 7 side.

For example, five LEDs of a first LED 10A to a fifth LED 10E are arranged on the document holding cover 9A shown in FIG. 4 and FIG. 5. The first LED 10A to the fifth LED 10E are suitably arranged according to whether the positioning reference of the document 4 is made the corner as shown in FIG. 4 or made the center as shown in FIG. 5. Besides, consideration is given to AB series or LT series, and they are suitably arranged. Further, the control of the LEDs 10A to 10E is performed by the LED controller 11A not shown in FIG. 4 and FIG. 5.

Here, HP1 and HP2 shown in FIG. 4 and FIG. 5 denote the first home position and the second home position shown in FIG. 2. The first home position is the initial position of the first carriage 16 at the time of document size detection. At the first home position, the light emitted from the first LED 10A to the fourth LED 10D is received by the CCD line sensor 26 through the first mirror 15, the second mirror 18, the third mirror 19, and the condenser lens 22.

The second home position is a position where the first carriage 16 at the time of document size detection is moved from the first home position and the light emitted from the fifth LED 10E is received by the CCD line sensor 26.

Hereinafter, for convenience of explanation, it is assumed that the LEDs 10 arranged on the document holding cover 9A are those of the example shown in FIG. 4 and a description will be made.

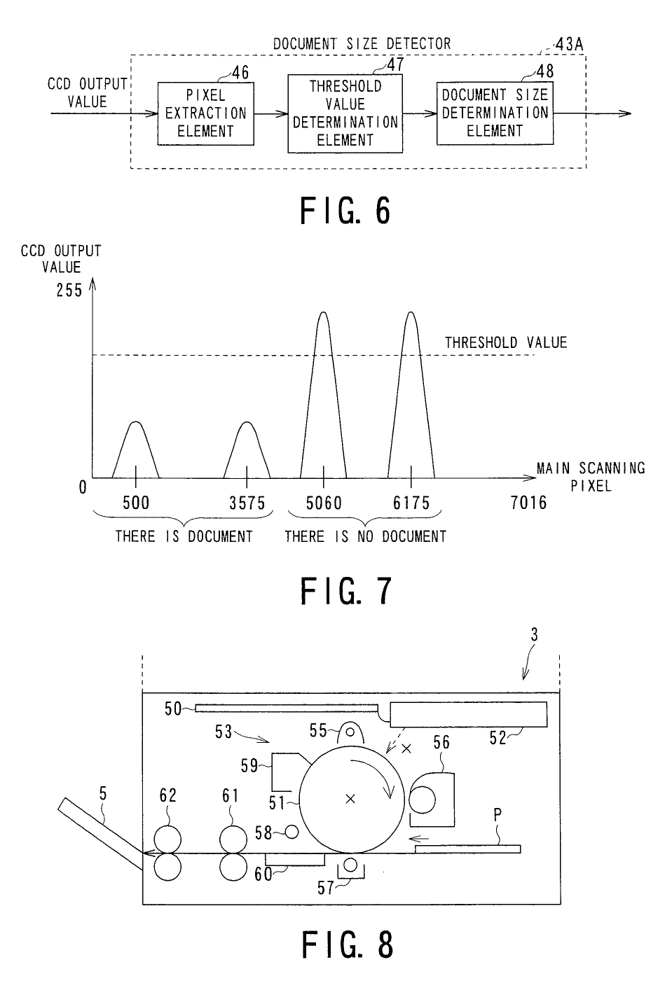

FIG. 6 is a schematic view showing the structure of the document size detector 43A.

The document size detector 43A includes a pixel extraction element 46 to extract pixels and the vicinity corresponding to the arrangement positions of the respective LEDs 10A to 10E, a threshold value determination element 47 to determine the presence/absence of the document 4 based on the result obtained by comparison with a specified threshold value, and a document size determination element 48 to determine the size of the positioned document 4 based on the result determined by the threshold value determination element 47.

CCD output signals obtained when the CCD line sensor 26 receives the light emitted from the respective LEDs 10A to 10E are inputted to the document size detector 43A after various signal processings such as A/D conversion are performed. The CCD output signals after the signal processing are first inputted to the pixel extraction element 46.

In the pixel extraction element 46, pixels corresponding to the previously determined arrangement positions of the respective LEDs 10A to 10E and pixels in the vicinities thereof (hereinafter referred to as pixel groups) are extracted among pixels in a main scanning direction read by the CCD line sensor 26.

In the case where the document 4 is, for example, an A4-size document, the size is 297 mm in a long side direction and 210 mm in a short side direction. In the case where the document read operation is performed while the long side direction is made the main scanning direction and the short side direction is made the sub-scanning direction, it is necessary that the number of effective pixels of the photodiode array of the CCD line sensor 26 is at least 7016 pixels (4677 pixels at the time of 400 dpi). In general, the sensor has 7500 pixels (5000 pixels at the time of 400 dpi).

For example, in the case where the number of effective pixels of the photodiode array of the CCD line sensor 26 is 7016 pixels, and the LEDs 10A to 10E are previously arranged at positions shown in FIG. 4, the output of the first LED 10A is the 500th pixel, the output of the second LED 10B and the fifth LED is the 3575th pixel, the output of the third LED 10C is the 5060th pixel, and the output of the fourth LED 10D is the 6175th pixel.

The pixel extraction element 46 extracts pixels in a specified range including the corresponding pixel, for example, five forward pixels and five backward pixels from each of the corresponding pixels. In the case where the range of pixels to be extracted is made to have five forward pixels and five backward pixels, the output of the first LED 10A is 495th to 505th pixels, the output of the second LED 10B and the fifth LED is 3570th to 3580th pixels, the output of the third LED 10C is 5055th to 5065th pixels, and the output of the fourth LED 10D is 6170th to 6180th pixels.

The pixel positions correspond to the respective document sizes (in the example shown in FIG. 4, A5-R, A5, A4-R, B4, A4). In the document holding cover 9A shown in FIG. 4, as an example, it is meant that the LEDs 10A to 10E are arranged outside the respective document sizes by +5 mm.

When extracting the pixel groups corresponding to the positions of the respective LEDs 10A to 10E, the pixel extraction element 46 transmits CCD output signals (0 to 255) as to the respective pixels of the extracted pixel groups to the threshold value determination element 47.

The threshold value determination element 47 calculates the maximum value from the data of 11 pixels extracted for each of the LEDs 10A to 10E. The maximum value is calculated at each of the arrangement positions of the respective LEDs 10A to 10E. The presence/absence of the document 4 is determined by comparing the calculated maximum value with a specified threshold value.

At this time, the LED 10 is adjusted so that the level of the CCD output signal (hereinafter referred to as the CCD output value) in the state where there is no document 4 becomes saturated (255). The threshold value based on which the presence/absence of the document 4 is determined is a CCD output value at the time when transmission is performed through a sheet having a basis weight of 45 g/m2, which is thinnest among generally used sheets.

FIG. 7 is a view for explaining the concept of a threshold value determination performed by the threshold value determination element 47.

For example, in the case where the LEDs 10A to 10E are arranged as shown in FIG. 4, and the document 4 of the A4-R size is placed, a threshold value determination result as shown in FIG. 7 is obtained. In the case where the A4-R document 4 is placed, since the first LED 10A, the second LED 10B, and the fifth LED 10E are shaded from the light, the CCD output values as to the first LED 10A, the second LED 10B, and the fifth LED 10E are small values.

On the other hand, since the third LED 10C and the fourth LED 10D are not shaded from the light, the CCD output values as to the third LED 10C and the fourth LED 10D are output values close to 255. By performing the determination as stated above, the shaded LEDs 10 can be detected.

The threshold value determination element 47 determines whether each of the LEDs 10A to 10E is shaded from the light, and transmits the determination result to the document size determination element 48.

The document size determination element 48 performs a document size determination based on the received LED shading determination result and information indicated in the following Table 1.

The word “ON” in each LED item indicated in Table 1 denotes a state (there is document) in which shading is performed by the document 4, and “OFF” indicates there is no document. Besides, “-” denotes neglect (Don't Care).

TABLE 1

| First | Second | Third | Fourth | Fifth | |
|---|---|---|---|---|---|
| LED | LED | LED | LED | LED | Document size |
| OFF | — | — | — | — | there is no document |
| ON | OFF | OFF | OFF | OFF | A5-R |
| ON | ON | OFF | OFF | OFF | A5 |
| ON | ON | ON | ON | OFF | A4 |
| ON | ON | OFF | OFF | ON | A4-R |
| ON | ON | ON | OFF | ON | B4 |
| ON | ON | ON | ON | ON | A3 |

As stated above, the document size determination element 48 can make the determination on the document size based on the received LED shading determination result and the information indicated in the following Table 1.

After making the determination on the document size, the document size determination element 48 transmits the information of the determination result to the processing IC 29 shown in FIG. 3. Incidentally, in the case where a combination other than those recited in Table 1 occurs, the processing IC 29 makes a determination that the form of the document is indefinite, and requests size designation from the user through a user interface such as a control panel 64 (see FIG. 9 to FIG. 11).

Next, the structure and operation of the printer 3 in the image copier 1A will be described.

FIG. 8 is a schematic view showing the structure of the printer 3. The printer 3 shown in FIG. 8 is described as an example of a structure to generate a monochrome image.

The printer 3 includes an image processing board 50 as an image processing unit, a laser optical system unit 52 and an image formation unit 53. The image processing board 50 performs a processing which is necessary for generating an image, for example, a processing of converting information read by the CCD line sensor 26 into a control signal of a not-shown light emitting element such as a semiconductor laser. The laser optical system unit 52 includes the light emitting element, such as the semiconductor laser to form a latent image on a photoreceptor drum 51.

The image formation unit 53 includes the photoreceptor drum 51 necessary for generating an image by an electrophotographic process, a charger 55, a developer 56, a transfer charger 57, a peeling charger 58, a cleaner 59, a sheet transport mechanism 60 to transport a sheet P, and a fuser 61. The sheet P on which an image is formed by the image formation unit 53 is outputted to the sheet discharge tray 5 through a discharge roller 62 to discharge the sheet P to the outside of the machine body.

For example, as shown in FIG. 9, the image copier 1A constructed as stated above can be used as an image copier in which a system controller 65 controls the scanner 2A and the printer 3 based on the input of the user from the control panel 64 so that an image copying operation is performed.

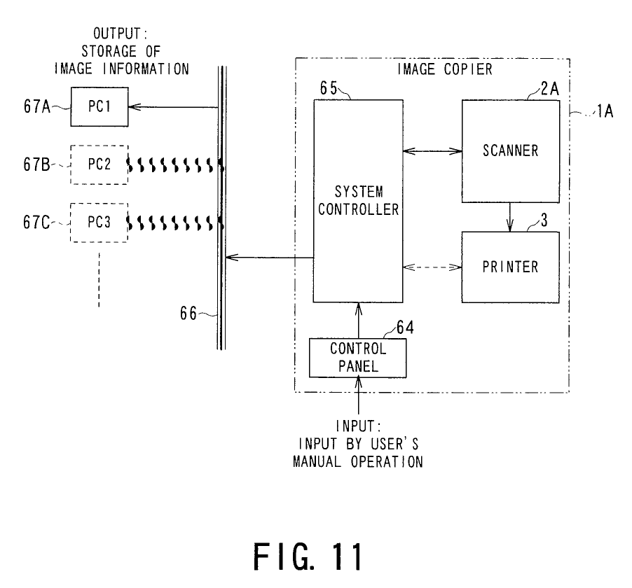

Further, as shown in FIG. 10, it can also be used as a printer to perform a printing operation based on the input from external computers (hereinafter referred to as a first PC 67A, a second PC 67B, a third PC 67C . . . ) connected through a network 66. Furthermore, as shown in FIG. 11, it can also be used as a scanner to store image information into an arbitrary external computer (for example, the first PC 67A) connected through the network 66 based on the input of the user from the control panel 64.

Next, an image copying method of the first embodiment of the invention will be described.

The image copying method of the first embodiment of the invention includes a document size detection step of detecting a size of the document 4, an image read step of reading an image from the document 4, and an image formation step of forming the image read at the image read step. The image copying method of the invention is characterized in a method of detecting the size of the document 4, that is, the document size detection step.

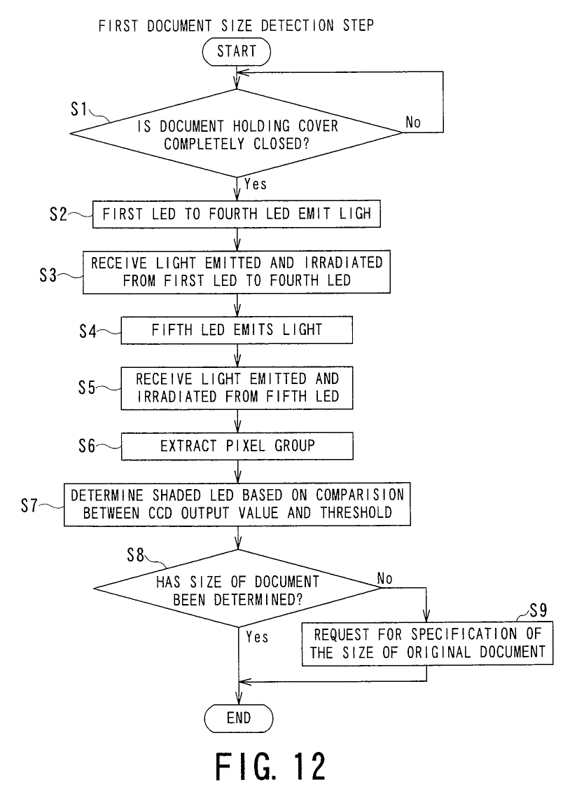

FIG. 12 is a flowchart for explaining the document size detection step (hereinafter referred to as a first document size detection step) in the image copying method of the first embodiment of the invention.

The first document size detection step is performed in the case where a mode of automatically detecting the size of the document 4 is selected.

The first document size detection step includes a document holding cover closing confirmation step of detecting whether the document holding cover 9A is closed and confirming that the document holding cover 9A is closed (step S1), a document size detecting light emitting element step of causing the LEDs 10A to 10E as document size detecting light emitting elements to emit light (step S2, step S4), an irradiation light receiving step of receiving the irradiation light from the LEDs 10A to 10E (step S3, step S5), a pixel group extraction step of extracting specified pixel groups including pixels corresponding to the respective LEDs 10A to 10E (step S6), a threshold value determination step of determining whether CCD output values of the pixel groups extracted at the pixel extraction step exceed a previously set threshold value (step S7), a document size determination step of determining a size of a document as an image read object based on a determination result at the threshold value determination step (step S8), and a document size designation request step of requesting designation of a document size (step S9) in a case where the size of the document 4 can not be determined at the document size determination step (NO at step S8).

In the first document size detection step, first, it is detected at step S1 whether the document holding cover 9A is in a completely closed state. When the document holding cover 9A is in the completely closed state (in the case of YES at step S1), next, at step S2, the first LED 10A to the fourth LED 10D arranged at the positions corresponding to the first home position are caused to emit light.

The light emitted from the first LED 10A through the fourth LED 10D is received by the CCD line sensor 26 through the first carriage 16 standing by at the first home position, the second carriage 20 and the condenser lens 22 (step S3). At step S3, the fifth LED 10E and the light source 13 are switched off.

Next, when the first carriage 16 is moved to the second home position and the movement is completed, the fifth LED 10E arranged at the position corresponding to the second home position emits light (step S4). The light emitted from the fifth LED 10E is received by the CCD line sensor 26 through the first carriage 16 standing by at the second home position, the second carriage 20, and the condenser lens 22 (step S5). At step S5, the first LED 10A to the fourth LED 10D and the light source 13 are switched off.

When the irradiation light receiving step (step S3 and step 5) is completed, the pixel extraction element 46 extracts the specified pixel groups including the pixels corresponding to the LEDs 10 (step S6), the threshold value determination element 47 determines whether the respective LEDs 10A to 10E are shaded based on the extracted CCD output values of the pixel groups (step S7), and the document size determination element 48 makes a document size determination based on the LED shading determination result and the information indicated in Table 1 (step S8).

In the case where the determination of the document size can be made (in the case of YES at step S8), the first document size detection step is ended (END).

On the other hand, in the case where the document holding cover 9A is not in the completely closed state (in the case of NO at step S1), the processing step at step S1 is repeated until the document holding cover 9A becomes the completely closed state and standby is performed.

In the case where the determination of the document size has not been made (in the case of NO at step S8), the designation of the document size is requested to the user (step S9), and the first document size detection step is ended (END).

According to the image copier and the image copying method of the first embodiment of the invention, the light irradiated from the LED 10s in the state where the document holding cover 9A is closed is not reflected but is directly used. Then, the size of the document 4 can be detected.

Further, since the irradiation light from the LED 10s are directly used, it becomes possible to perform high-precision document size detection independent of the influence of external light and the kind of document.

Furthermore, in the image copier 1A, since the CCD line sensor 26 as the image reading light receiving element is used also as the document size detecting light receiving element, a new light receiving element for document size detection is unnecessary, and costs can be reduced.

Incidentally, in the image copier 1A, although the description has been given to the case where the LED 10 is used as the document size detecting light emitting element, an organic EL (Electro Luminescence) or another light emitting element to emit a visible light may be used instead of the LED 10.

Further, although the description has been given to the case where the CCD line sensor 26 is used as the image reading light receiving element, a CIS (Contact Image Sensor) may be used instead of the CCD line sensor 26.

Furthermore, although the size of the document 4 in the long-side direction is detected by using the fifth LED 10E, in order to improve the performance, the image copier 1A may be constructed such that the fifth LED 10E is eliminated, a conventional document size detection sensor having light emitting/receiving elements is arranged in the scanner 2A, and the document size detection is performed based on the detection result.

### Second Embodiment

An image copier 1B as an example of an image copier of a second embodiment of the invention is different from the image copier 1A shown in FIG. 1 in that a scanner 2B is provided instead of the scanner 2A, however, they are substantially the same in other points. That is, in the structure of the image copier 1B, the image copier 1A and the scanner 2A shown in FIG. 1 may be read as the image copier 1B and the scanner 2B, respectively.

Next, the structure and operation of the scanner 2B in the image copier 1B will be described.

FIG. 13 is a schematic view showing the structure of the scanner 2B.

As shown in FIG. 13, the scanner 2B is different from the scanner 2A shown in FIG. 2 in that instead of the document holding cover 9A, a document holding cover 9B is openably and closably provided to the casing 8, and that instead of the control board 25A, a control board 25B is provided to the scanner 2B, however, they are substantially the same in other points. Therefore, structural elements which are substantially the same are denoted by the same reference numerals and their description will be omitted.

In the document holding cover 9B, instead of the document size detecting light emitting element (LED 10) arranged in the document holding cover 9A, document size detecting light receiving elements are arranged. As the document size detecting light receiving element, for example, a photodiode (hereinafter referred to as a PD) 70 is adopted.

Besides, the control of the PD 70 and a necessary signal processing such as A/D conversion are performed by a PD controller 71 provided in the document holding cover 9B.

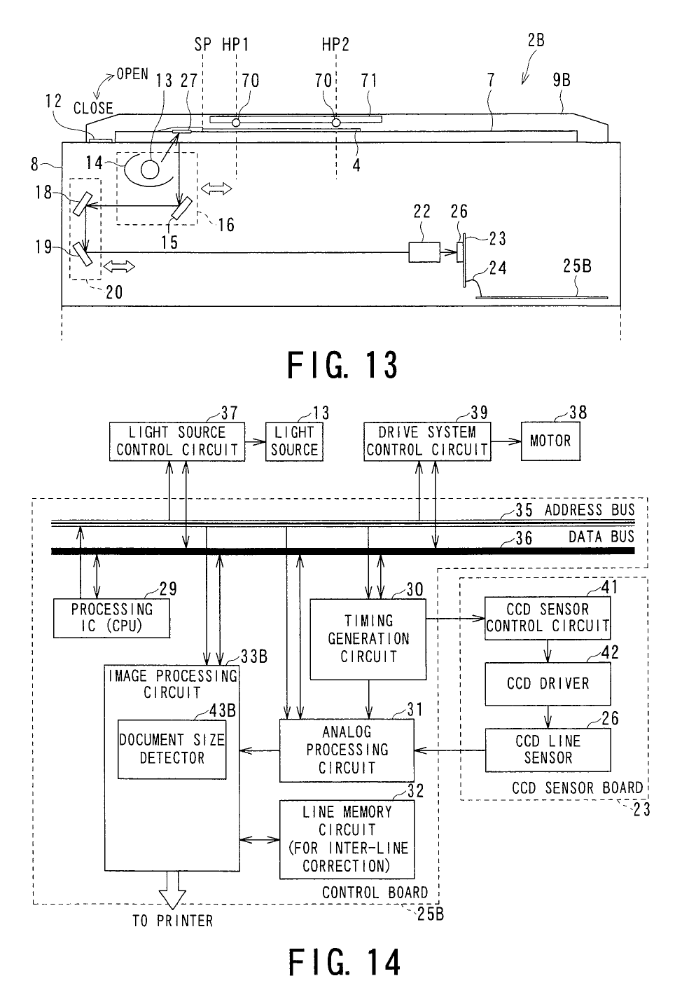

On the other hand, FIG. 14 is a schematic view for explaining a structure and a control object of the control board 25B.

As shown in FIG. 14, the control board 25B is different from the control board 25A shown in FIG. 3 in that a document size detector 43B is included instead of the document size detector 43A in the image processing circuit 33A, however, they are substantially the same in other points. Then, structural elements other than the document size detector 43B are denoted by the same reference numerals and their description will be omitted.

Next, the structure of the document size detector 43B and a document size detection method performed by the document size detector 43B will be described.

As shown in FIG. 13, the plural PDs 70 arranged at specified positions of the document holding cover 9B receive light irradiated from a light source 13, and the output levels of the PDs 70 are determined, so that the document size detector 43B detects whether a document 4 exists on optical paths between the light source 13 and the PDs 70. Then, the size of the document 4 is determined based on the detection result of the document 4.

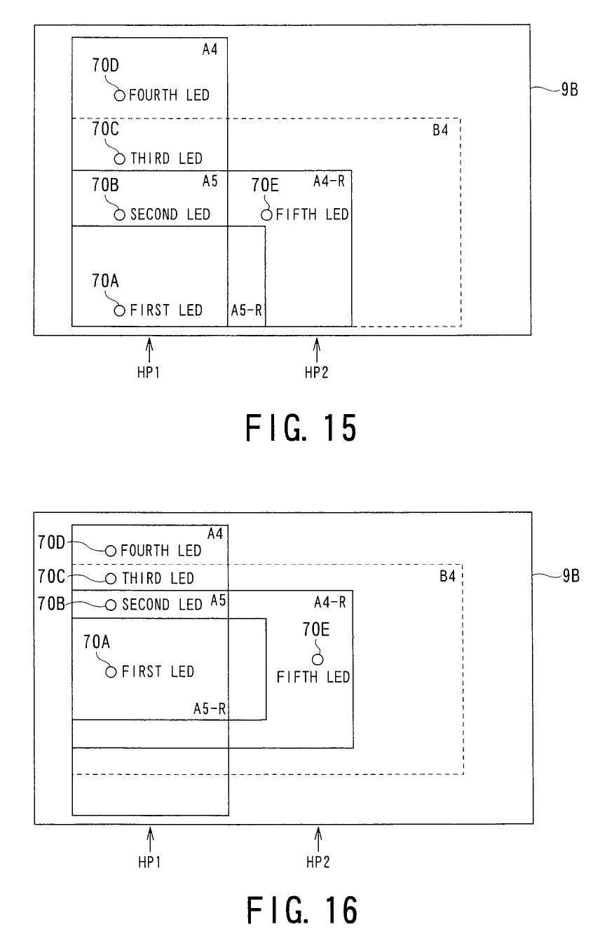

FIG. 15 and FIG. 16 are plan views in the case where the document holding cover 9B of the scanner 2B in the image copier 1B is seen from a document table glass 7 side.

In the document holding cover 9B shown in FIG. 15 and FIG. 16, for example, five PDs of a first PD 70A to a fifth PD 70E are arranged. Away of thinking on the arrangement of the first PD 70A to the fifth PD 70E is similar to that of the case where the first LED 10A to the fifth LED 10E are arranged. The control of the PDs 70A to 70E are performed by the PD controller 71 arranged in the document holding cover 9B and not shown in FIG. 15 and FIG. 16.

Hereinafter, for convenience of explanation, a description will be made while it is assumed that the PDs 70 arranged in the document holding cover 9B are those of the example in FIG. 15.

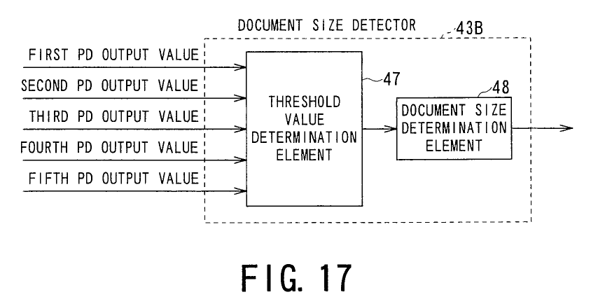

FIG. 17 is a schematic view showing a structure of the document size detector 43B.

The document size detector 43B includes a threshold value determination element 47 to determine the presence/absence of the document 4 based on the result of comparison with a specified threshold value, and a document size determination element 48 to determine the size of the positioned document 4 based on the result of the determination of the threshold value determination element 47.

Respective PD output signals (a first PD output signal to a fifth PD output signal) obtained as a result that the respective PDs 70A to 70E receive the light irradiated from the light source 13 are inputted to the document size detector 43B after various signal processings such as A/D conversion are performed. The PD output signals after the signal processings are first inputted to the threshold value determination element 47.

In the threshold value determination element 47, the respective inputted PD output signals (PD output signal values) and a specified threshold value are compared with each other. The PD output signal value is adjusted so that it becomes saturated (255) in a state where there is no document 4. Accordingly, in the case where the PD output signal value is larger than the specified threshold value, the threshold value determination element 47 determines that there is no document 4, and in the case where it is smaller, a determination is made that the document 4 exists. Then, the document presence/absence determination result (shading determination result) is inputted from the threshold value determination element 47 to the document size determination element 48.

The document size determination element 48 makes a document size determination based on the shading determination result and information indicated in the following Table 2. Then, the information of the determination result is transmitted to a processing IC 29 shown in FIG. 14. Note that in the case where a combination other then those indicated in Table 2 occurs, the processing IC 29 determines that the form of the document is indefinite, and requests size designation from the user through a user interface such as a control panel 64 (see FIG. 9 to FIG. 11).

Incidentally, the word “ON” in each PD item shown in Table 2 indicates a state (there is a document) where shading is performed by the document 4, and “OFF” indicates there is no document. Besides, “-” indicates neglect (Don't Care)

TABLE 2

| First | Second | Third | Fourth | Fifth | |
|---|---|---|---|---|---|
| PD | PD | PD | PD | PD | Document size |
| OFF | — | — | — | — | there is no document |
| ON | OFF | OFF | OFF | OFF | A5-R |
| ON | ON | OFF | OFF | OFF | A5 |
| ON | ON | ON | ON | OFF | A4 |
| ON | ON | OFF | OFF | ON | A4-R |
| ON | ON | ON | OFF | ON | B4 |
| ON | ON | ON | ON | ON | A3 |

Similarly to the image copier 1A, the image copier 1B constructed as stated above can be used as shown in FIG. 9 to FIG. 11.

Next, an image copying method of the second embodiment of the invention will be described.

The image copying method of the second embodiment of the invention is different from the image copying method of the first embodiment of the invention in a partial processing step of a document size detection step of detecting the size of the document 4, however, they are substantially the same in an image read step and an image formation step. Then, the document size detection step (hereinafter referred to as a second document size detection step) in the image copying method of the second embodiment of the invention will be described.

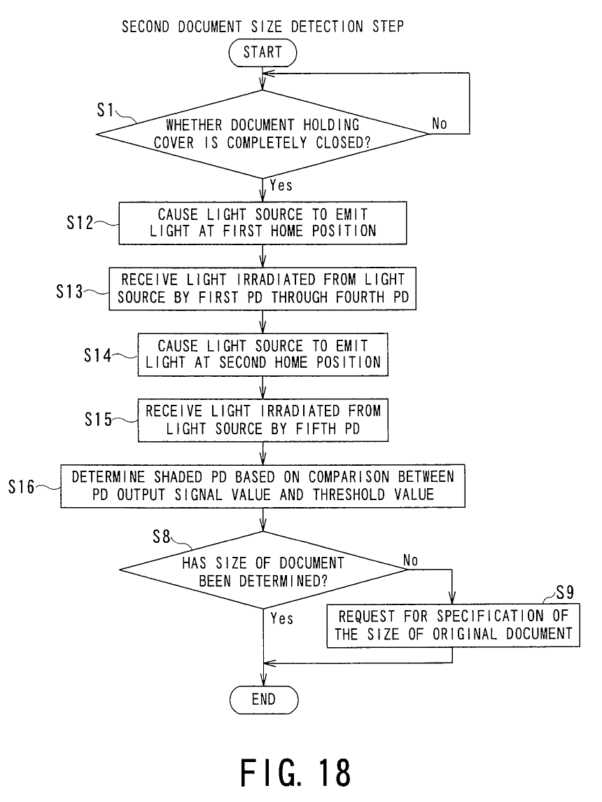

FIG. 18 is a flowchart for explaining the document size detection step (second document detection step) in the image copying method of the second embodiment of the invention.

Incidentally, in the second document detection step, processing steps which are substantially the same as those of the first document detection step are denoted by the same step numbers and their description will be omitted.

The second document size detection step is performed in the case where a mode of automatically detecting the size of the document 4 is selected.

The second document size detection step includes a document holding cover closing confirmation step (step S1), an image reading light emitting element step of causing the light source 13 as the image reading light emitting element, which is used also as the document size detecting light emitting element, to emit light (step S12, step S14), an irradiation light receiving step of receiving the light irradiated from the light source 13 (step S13, step S15), a threshold value determination step of determining whether PD signal output values of the respective PDs 70A to 70E received at the irradiation light receiving step exceed a previously set threshold value (step S16), a document size determination step (step S8), and a document size designation request step of requesting the designation of a document size (step S9) in a case where the size of the document 4 can not be determined at the document size determination step (in the case of NO at step S8).

In the second document size detection step, first, when the document holding cover 9B is in a completely closed state (in the case of YES at step S1), next, the light source 13 standing by at the first home position at step S12 is caused to emit light. The light emitted from the light source 13 is received by each of the first PD 70A to the fourth PD 70D arranged at the positions corresponding to the first home position (step S13).

Subsequently, when the first carriage 16 moves to the second home position and the movement is completed, the light source 13 emits light (step S14), and the light irradiated from the light source 13 is received by the fifth PD 70E arranged at the position corresponding to the second home position (step S15).

When the irradiation light receiving step (step S13 and step S15) is completed, based on the PD signal output values of the respective PDs 70A to 70E received by the threshold value determination element 47, it is determined whether the light from the light source 13 is shaded (step S16), and the document size determination element 48 makes a document size determination based on the shading determination result and the information indicated in Table 2 (step S8). In the case where the determination of the document size can be made (in the case of YES at step S8), the second document size detection step is ended (END).

Note that processing steps performed in the case of NO at step S1 and in the case of NO at step S8 are similar to those of the first document size detection step.

According to the image copier and the image copying method of the second embodiment of the invention, the light irradiated from the light source 13 in the state where the document holding cover 9B is closed is not reflected but is directly used, and the size of the document 4 can be detected.

Further, since the irradiation light from the light source 13 is directly used, it becomes possible to perform the high-precision document size detection independent of the influence of external light and the kind of document.

Furthermore, in the image copier 1B, since the light source 13 as the image reading light emitting element is used also as the document size detecting light emitting element, a new light emitting element for document size detection is unnecessary, and costs can be reduced.

### Third Embodiment

An image copier 1C as an example of an image copier of a third embodiment of the invention is different from the image copier 1A shown in FIG. 1 in that a scanner 2C is provided instead of the scanner 2A, however, they are substantially the same in other points. That is, in the structure of the image copier 1C, the image copier 1A and the scanner 2A shown in FIG. 1 may be read as the image copier 1C and the scanner 2C, respectively.

Next, the structure and operation of the scanner 2C in the image copier 1C will be described.

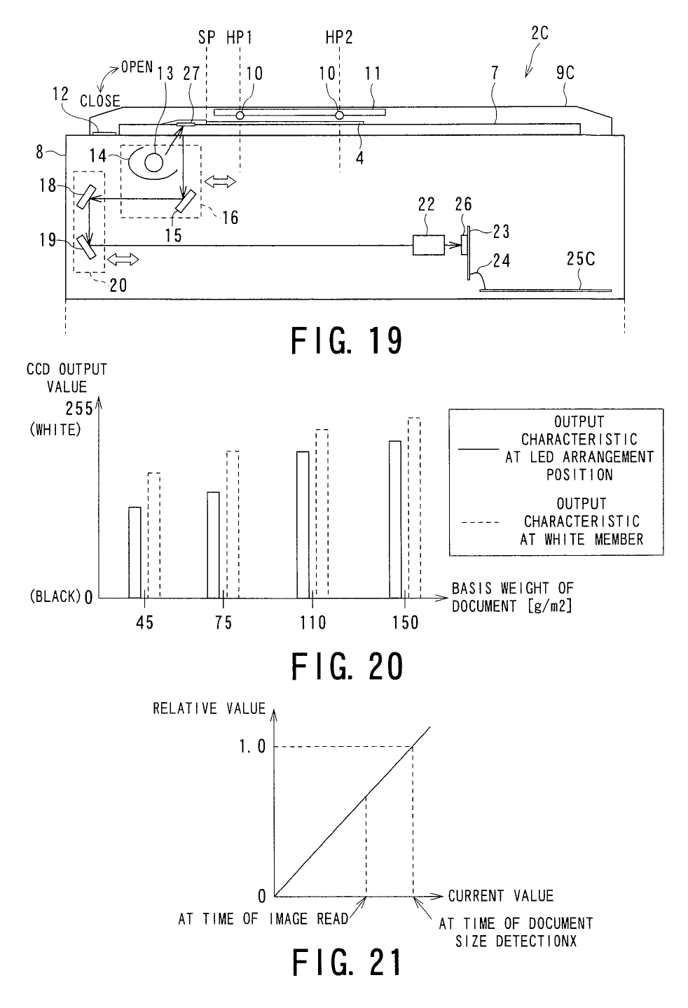

FIG. 19 is a schematic view showing the structure of the scanner 2C.

As shown in FIG. 19, the scanner 2C is different from the scanner 2A shown in FIG. 2 in that instead of the document holding cover 9A, a document holding cover 9C is openably and closably provided to a casing 8, however, they are substantially the same in other points. Accordingly, structural elements which are substantially the same are denoted by the same reference numerals and their description will be omitted.

In the document holding cover 9C, as compared with the document holding cover 9A, an LED controller 11C is provided instead of the LED controller 11A. The LED controller 11C is different from the LED controller 11A in that the LEDs 10 are controlled to emit light not only at the time of document detection but also at the time of image detection. That is, the document holding cover 9C is such that the document holding cover 9A is further improved.

A conventional document holding cover including the document holding cover 9A is generally configured by a white material so that a see-through copying of the bottom side of the document 4 does not occur. However, since the LEDs 10A to 10E are arranged in the document holding cover 9A, the document holding cover 9A has such a structure that holes (hereinafter referred to as LED arrangement holes) for arrangement of the LEDs 10A to 10E are opened. The LED arrangement holes become shadows at the time of document read, and cause image noise.

Therefore, in the document holding cover 9C, in order to prevent the image noise, that is, the occurrence of the shadow, the LEDs 10 are caused to emit light also at the time of document read, so that the white degree almost equivalent to the white of the document holding cover is realized and the see-through copying of the bottom side of the document is suppressed.

FIG. 20 is a view for explaining a relation between the basis weight of the document 4 and the CCD output value of the CCD line sensor 26.

Generally used sheets include sheets from a thin paper having a basis weight of 45 g/m2 to a thick paper having a basis weight of 150 g/m2. With respect to these sheets, the output value of the CCD line sensor 26 at the LED arrangement position (LED is switched off) has a relation indicated by a solid line of FIG. 20. On the other hand, the read value of the CCD line sensor 26 at a place (white member) other than the LED arrangement position has a relation indicated by a broken line. As shown in FIG. 20, at the arrangement position of the LEDs 10, the light irradiated from the line source 13 passes through the document 4 and is absorbed by the LED arrangement hole, and accordingly, the CCD output value is lowered. In order to compensate the quantity of the light absorbed by the LED arrangement hole, the LEDs 10 are caused to emit light.

The light emission quantity of the respective LEDs 10 is controlled by the LED controller 11C so that the output value of the CCD line sensor 26 at the arrangement position of the LEDs 10 are almost equal to the output value of the CCD line sensor 26 in the white member area (area other than the arrangement position of the LEDs 10) of the document holding cover 9C.

Besides, as shown in FIG. 21, the light emission quantity of the LED 10 has a correlation with the value of current passing through the LED 10. Then, the LED controller 11C controls the value of the current passing through the LED 10, so that the light emission quantity of the LED 10 is controlled.

Since the light emission quantity of the LED 10 at the time of image read has only to compensate the quantity of light absorbed by the LED arrangement hole, it may be smaller than the light emission quantity at the time of document size detection. That is, as shown in FIG. 21, the LED controller 11C controls the light emission quantity of the LED 10 and suppresses the see-through copying of the bottom side of the document at the time of image read by causing the value of current passing through the LED 10 at the time of image read to become a value different from the value of current passing through the LED 10 at the time of document size detection.

Next, an image copying method of a third embodiment of the invention will be described.

The image copying method of the third embodiment of the invention is different from the image copying method of the first embodiment of the invention in that the LEDs 10 as the document size detecting light emitting element emits light also at the image read step, however, they are substantially the same in other points.

According to the image copier and the image copying method of the third embodiment of the invention, in addition to the effects of the image copier and the image copying method of the first embodiment of the invention, the see-through copying of the bottom side of the document 4 at the time of image read can be suppressed by causing the LEDs 10 as the document size detecting light emitting element to emit light also at the time of image read.

As stated above, according to the invention, it is possible to perform the high-precision document size detection independent of the influence of external light and the kind of document. Besides, since the document size detecting light receiving element is used also as the CCD line sensor 26 as the image reading light receiving element, or the document size detecting light emitting element is used also as the light source 13 as the image reading light emitting element, costs can be reduced. Further, the see-through copying of the bottom side of the document can be suppressed by causing the LEDs 10 as the document size detecting light emitting element to emit light also at the time of image read.

Note that the invention is not directly limited to the above embodiments, and at the stage of practice, structural elements are modified and can be embodied within the range not departing from the gist of the invention. Besides, various inventions can be formed by suitable combination of plural structural elements disclosed in the embodiments. For example, some structural elements may be deleted from all structural elements disclosed in an embodiment. Further, structural elements of different embodiments may be suitably combined.

For example, in the present specification, although the description has been made on the assumption that the apparatus of the invention is the image copiers 1A to 1C, the invention can be applied to only the scanners 2A to 2C as an image read apparatus, or applied also to a document size detection apparatus which does not perform the image read of the document 4 but performs only the size detection.

Similarly, although the description has been made on the assumption that the method of the invention is the image copying method, an image read step including the document size detection step described in the specification can be applied as the image read method, or the document size detection step described in the specification can be applied as the document size detection method.

1. An image copier comprising a scanner configured to read an image and a printer configured to form the image on a sheet, wherein said scanner includes:
a document table configured to position a document from which the image is read;
a light source configured to irradiate a light to the document when the image of the document is read;
an image reading light receiving element configured to receive reflected light from the document;
a document holding cover configured to hold the document on the document table and to include a document size detecting light emitting element to emit light at a time of document size detection; and
a document size detecting light emitting element controller configured to control the document size detecting light emitting element.

2. The image copier according to claim 1, wherein said image reading light receiving element has a role as the document size detection light receiving element to receive the light emitted from the document size detecting light emitting element.

3. The image copier according to claim 2, wherein said document size detecting light emitting element controller controls the document size detecting light emitting element to emit light also at a time of image read in a case where the document exists at least between the document size detecting light emitting element and the document size detecting light receiving element.

4. The image copier according to claim 2, wherein said document size detecting light emitting element controller controls, in a case where the document exists at least between the document size detecting light emitting element and the document size detecting light receiving element, the document size detecting light emitting element to emit light having a light quantity different from that at the time of document detection at a time of image read.

5. The image copier according to claim 2, wherein said document size detecting light emitting element controller controls, in a case where the document exists at least between the document size detecting light emitting element and the document size detecting light receiving element, the document size detecting light emitting element to emit light having a light quantity equivalent to a difference between a light quantity of reflected light at a position where the document size detecting light emitting element is not arranged and a light quantity of reflected light at the document size detecting light emitting element at a time of image read.

6. The image copier according to claim 2, wherein said document size detecting light emitting element controller controls, in a case where the document exists relatively to at least the document size detecting light receiving element, the document size detecting light emitting element to emit light at a time of image read so that a line sensor output based on reflected light at a position where the document size detecting light emitting element is not arranged becomes equivalent to a line sensor output based on reflected light at the document size detecting light emitting element and transmitted light.

7. The image copier according to claim 2, wherein said document size detecting light emitting element controller controls a value of current passing through an LED at a time of image read to be smaller than a value of current passing through the LED at a time of document detection in a case where the document size detecting light emitting element is the LED.

8. The image copier according to claim 1, wherein said document size detecting light emitting element is arranged at a position where one document size is specified from plural different document sizes.

9. The image copier according to claim 1, wherein said document size detecting light emitting element is arranged at a position where one document size of plural different document sizes is specified from plural different document sizes.

10. The image copier according to claim 1, wherein said document size detecting light emitting element includes at least one of the LED and an organic EL.

11. An image copier comprising a scanner to read an image and a printer to form the image on a sheet, wherein said scanner comprises:
a document table configured to position a document from which the image is read;
a light source configured to irradiate light to the document when the image of the document is read;
an image reading light receiving element to receive reflected light from the document;
a document holding cover configured to hold the document on the document table and to include a document size detecting light receiving element to receive irradiation light from the light source at a time of document size detection; and
a document size detecting light emitting element controller configured to control the document size detecting light emitting element.

12. The image copier according to claim 11, wherein said light source emits light at the time of document size detection and has a role as a document size detecting light emitting element.

13. The image copier according to claim 11, wherein said document size detecting light emitting element is arranged at a position where one document size is specified from plural different document sizes.

14. The image copier according to claim 11, wherein the document size detecting light receiving element is a photodiode.

15. An image copying method comprising:
detecting a size of a document as an image read object;
reading an image from the document; and
forming the image read at the image read step,
wherein said document size detection step includes steps of:
receiving light irradiated by causing a document size detecting light emitting element to emit light;
extracting a specified pixel group including a pixel corresponding to the document size detecting light emitting element;
determining whether a CCD output value of the pixel group extracted at the pixel extraction step exceeds a previously set threshold value; and
determining the size of the document of the image read object based on a determination result at the threshold value determination step.

16. The image copying method according to claim 15, wherein said image read step includes a document size detecting light emitting element light emission step at which in a case where the document exists between the document size detecting light emitting element provided differently from at least a light source for image read and a document size detecting light receiving element, the document size detecting light emitting element emits light.

17. The image copying method according to claim 15, wherein said image read step includes a document size detecting light emitting element light emission step at which in a case where the document exists between the document size detecting light emitting element provided differently from at least a light source for image read and a document size detecting light receiving element, the document size detecting light emitting element emits light having a light quantity equivalent to a difference between a light quantity of reflected light at a position where the document size detecting light emitting element is not arranged and a light quantity of reflected light at the document size detecting light emitting element.

18. The image copying method according to claim 15, wherein said image read step includes a document size detecting light emitting element light emission step at which in a case where the document exists between the document size detecting light emitting element provided differently from at least a light source for image read and a document size detecting light receiving element, light is emitted so that a line sensor output based on reflected light at a position where the document size detecting light emitting element is not arranged becomes equivalent to a line sensor output based on reflected light at the document size detecting light emitting element and transmitted light.

19. The image copying method according to claim 15, wherein said document size detection step further includes a document holding cover closing confirmation step of detecting whether a document holding cover is closed and confirming that the document holding cover is closed.

20. An image copying method comprising:
detecting a size of a document as an image read object;
reading an image from the document; and
forming the image read at the image read step,
wherein said document size detection step includes:
receiving light irradiated by causing an image reading light emitting element to emit light;
determining whether a level of an output signal outputted from the image reading light receiving element having received the light at the irradiation light receiving step exceeds a previously set threshold value; and
determining the size of the document of the image read object based on a determination result at the threshold value determination step.
